(19) United States
(12) Patent Application Publication
(10) Pub. No.: US 2024/0407411 A1
(43) Pub. Date: Dec. 12, 2024

(54) FREEZE-DRIED POWDERED FISH PASTE AND METHOD FOR MANUFACTURING THE SAME

(71) Applicant: SAMJIN FOOD CO., LTD., Busan (KR)

(72) Inventor: Yong Joon PARK, Busan (KR)

(21) Appl. No.: 18/739,474

(22) Filed: Jun. 11, 2024

(30) Foreign Application Priority Data
Jun. 12, 2023 (KR) 10-2023-0075184

(51) Int. Cl. A23L 17/10

(52) U.S. Cl. CPC A23L 17/10

(57) ABSTRACT

Disclosed are freeze-dried powdered fish paste and a method for manufacturing the same. The method of manufacturing freeze-dried powdered fish paste according to the present disclosure does not require the preceding thawing and mixing processes of a conventional fish cake manufacturing process, thereby reducing production costs, significantly increasing gel strength, and enabling the production of fish paste with improved quality (taste, chewiness, and hardness).

### TECHNICAL FIELD

The present disclosure relates to freeze-dried powdered fish paste and a method for manufacturing the same. The method for manufacturing the freeze-dried powdered fish paste according to the present disclosure does not require the preceding thawing and mixing processes of a conventional fish cake manufacturing process, thereby reducing production costs, significantly increasing gel strength, and enabling the production of fish paste with improved quality (taste, chewiness, and hardness).

### BACKGROUND

Fish cake is made by utilizing the salt solubility of myofibrillar proteins (actomyosin) in frozen surimi (fish meat) to create a network structure. The fish cake contains large amounts of amino acids and unsaturated fatty acids, which provide nutrition to the human body, lower cholesterol, and are especially convenient to cook and eat, making them widely consumed as a side dish or snack.

Typically, fish cake is manufactured by adding salt to the fish meat to extract the myofibrillar proteins in a blending process. The resulting fish-based intermediate product is then freeze-dried, ground, and mixed with other additives such as wheat flour and kelp powder. FIG. 1 is a diagram illustrating a conventional fish cake manufacturing process. This conventional process includes a natural thawing step S1, a first grinding step S2, a first drying step S3, a second drying step S4, a third drying step S5, a second grinding step S6, a mixing step S7, and a vacuum packaging step S8. In the first grinding step S2, the thawed fish meat is seasoned with salt, sodium saccharin, and monosodium glutamate before grinding. However, because the conventional manufacturing process requires the blending step S2 to extract myofibrillar proteins from the fish meat, production costs are increased. In addition, after being powdered and rehydrated to form a fish-based intermediate product, issues such as natural coagulation and refreezing during fish paste production can lead to a decline in quality.

### RELATED DOCUMENT

1. Patent Document: Korea Patent No. 10-0824598

### SUMMARY

In an effort to address the aforementioned conventional issues, the inventors of the present disclosure discovered that by grinding pretreated frozen surimi into powder and mixing the powder with additives, without performing the preceding thawing process (step S1 in FIG. 1) and mixing process (step S2 in FIG. 1) in a conventional fish cake manufacturing method, not only does the gel strength of the fish cake significantly increase, but the quality (taste, chewiness, and hardness) also improves.

However, the objectives of the present application are not limited to the aforementioned objective, and other objectives not mentioned will be clearly understood by those skilled in the art from the description below.

In one aspect, there is provided a method for manufacturing freeze-dried powdered fish paste, and the method includes:
a pretreating step of pretreating frozen surimi;
a first drying step of drying the pretreated frozen surimi at 5 to 15° C. for 10 to 15 hours under a vacuum pressure of 10⁴ Pa to 10⁶ Pa;
a second drying step of drying the first-dried surimi at 15 to 25° C. under a vacuum pressure of 10⁴ Pa to 10⁶ Pa for 1 to 3 hours;
a third drying step of drying the second-dried surimi at 25 to 35° C. for 10 to 15 hours under a vacuum pressure of 10⁴ Pa to 10⁶ Pa;
a fourth drying step of drying the third-dried surimi at 35 to 45° C. for 20 to 30 hours under a vacuum pressure of 10⁴ Pa to 10⁶ Pa;
a grinding step of powdering the fourth-dried surimi; and
a mixing step of mixing additives with the ground surimi powder.

In the present disclosure, the pretreating step may include cutting the frozen surimi into pieces with a thickness of 1 to 1.5 cm and rapidly freezing the pieces at −80° C. to −40° C.

In the present disclosure, the mixing step may include mixing additives including wheat starch, potato starch, refined salt, sugar, nucleic acid 2.5, D-xylose and glycine with the ground surimi powder.

In the present disclosure, the mixing step may include 65 to 75 weight % ground surimi powder, 10 to 15 weight % wheat starch, 8 to 13 weight % potato starch, 3 to 5 weight % refined salt, 0.5 to 2 weight % sugar, 0.5 to 1.5 weight % nucleic acid, 0.5 to 1 weight % D-xylose, and 0.1 to 0.3 weight % glycine based on a total weight of the freeze-dried powdered fish paste.

In the present disclosure, the method may further include, after the mixing step, a packaging step of subdividing and packaging the surimi powder.

In another aspect, there is provided a fish cake manufacturing method including:
a preparing step for preparing surimi powder manufactured by the method for manufacturing freeze-dried powdered fish paste according to any one of claims 1 to 5;
an intermediate product manufacturing step of manufacturing a paste-like fish-based intermediate product by adding purified water to the surimi powder and mixing the purified water with the surimi powder; and
a fish cake manufacturing step of manufacturing fish cake by shaping and heating the fish-based intermediate product.

In the present disclosure, the heating may include boiling, roasting, or steaming.

The method for manufacturing freeze-dried powdered fish paste according to the present disclosure does not require a thawing process (step S1 in FIG. 1) and mixing process (step S2 in FIG. 1) of the conventional fish cake manufacturing process, thereby reducing the manufacturing cost. In addition, when fish cake is manufactured using surimi powder manufactured by the method for manufacturing freeze-dried powdered fish pastes according to the present disclosure, not only is the gel strength of the fish cakes significantly increased, but the quality can also (taste, chewiness, and hardness) be improved.

Meanwhile, the scope of the present disclosure is not limited by the effects described above.

### BRIEF DESCRIPTION OF THE DRAWINGS

FIG. 1 is a diagram illustrating a conventional fish paste manufacturing process.

FIG. 2 is a diagram illustrating a manufacturing process of freeze-dried powdered fish paste according to the present disclosure.

FIG. 3 is a diagram illustrating a manufacturing process of fish cake according to the present disclosure.

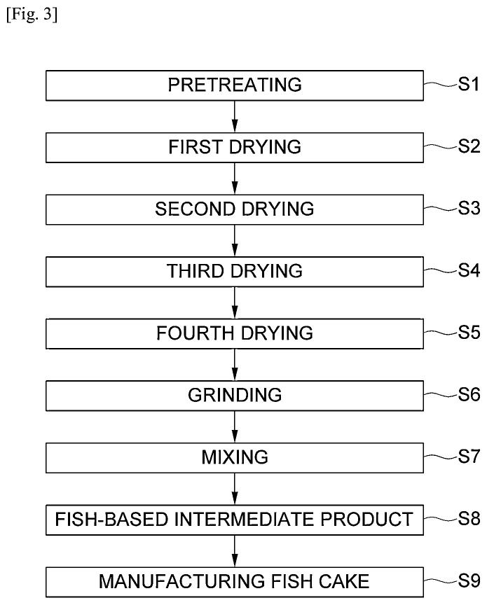

### DETAILED DESCRIPTION

Hereinafter, freeze-dried powdered fish paste and a method for manufacturing the same according to specific embodiments of the present disclosure will be described in detail. However, these are for illustrative purposes only, and the scope of the present disclosure is not intended to be limited thereby. It will be apparent to those skilled in the art that various modifications may be made thereto without departing from the scope of the present disclosure. In addition, the term “including” or “containing” means including a particular component (or particular element) without particular limitations unless otherwise mentioned in the present entire disclosure, and it cannot be interpreted as excluding the addition of the other components.

According to a first embodiment, the present disclosure provides a method for manufacturing freeze-dried powdered fish paste, which includes
a pretreating step S1 of pretreating frozen surimi;
a first drying step S2 of drying the pretreated frozen surimi at 5 to 15° C. for 10 to 15 hours under a vacuum pressure of 10⁴ Pa to 10⁶ Pa;
a second drying step S3 of drying the first-dried surimi at 15 to 25° C. under a vacuum pressure of 10⁴ Pa to 10⁶ Pa for 1 to 3 hours;
a third drying step S4 of drying the second-dried surimi at 25 to 35° C. for 10 to 15 hours under a vacuum pressure of 10⁴ Pa to 10⁶ Pa;
a fourth drying step S5 of drying the third-dried surimi at 35 to 45° C. for 20 to 30 hours under a vacuum pressure of 10⁴ Pa to 10⁶ Pa;
a grinding step S6 of grinding the fourth-dried surimi into powder; and
a mixing step S7 of mixing additives with the surimi powder.

In the method for manufacturing freeze-dried fish paste powder according to the present disclosure, the surimi may include sailfin sandfish, squid, baby octopus, mackerel, croaker, or Spanish mackerel, but is not limited thereto.

In the method for manufacturing freeze-dried powdered fish paste according to the present disclosure, the pretreating step S1 of pretreating the frozen surimi may include cutting the frozen surimi into pieces with a thickness of 1 to 1.5 cm and rapidly freezing the pieces at −80° C. to −40° C.

In the method for manufacturing freeze-dried powdered fish paste according to the present disclosure, the first drying step S2 may include drying the pretreated frozen surimi at 10° C. for 12 hours under a vacuum pressure of 105 Pa.

In the method for manufacturing freeze-dried powdered fish paste according to the present disclosure, the second drying step S3 may include drying the first-dried surimi at 20° C. for 2 hours under a vacuum pressure of 105 Pa.

In the method for manufacturing freeze-dried powdered fish paste according to the present disclosure, the third drying step S4 may include drying the second-dried surimi at 30° C. for 12 hours under a vacuum pressure of 105 Pa.

In the method for manufacturing freeze-dried powdered fish paste according to the present disclosure, the fourth drying step S5 may include drying the third-dried surimi at 40° C. for 25 hours under a vacuum pressure of 105 Pa.

In the method for manufacturing freeze-dried powdered fish paste according to the present disclosure, the grinding step S6 may include grinding the fourth-dried surimi into powder with particles of 150 to 200 mesh.

In the method for manufacturing freeze-dried powdered fish paste according to the present disclosure, the mixing step S7 may include mixing additives such as wheat starch, potato starch, refined salt, sugar, nucleic acid 2.5, D-xylose, and glycine with the ground surimi powder to produce freeze-dried powdered fish paste. The produced freeze-dried powdered fish paste may include 65 to 75 weight % ground surimi powder, 10 to 15 weight % wheat starch, 8 to 13 weight % potato starch, 3 to 5 weight % refined salt, 0.5 to 2 weight % sugar, 0.5 to 1.5 weight % nucleic acid, 0.5 to 1 weight % D-xylose, and 0.1 to 0.3 weight % glycine based on a total weight of the freeze-dried powdered fish paste. For example, the produced freeze-dried powdered fish paste may include 68.68 weight % freeze-dried frozen surimi powder (surimi powder), 13.74 weight % wheat starch, 10.30 weight % potato starch, 4.12 weight % refined salt, 1.37 weight % sugar, 0.96 weight % nucleic acid (2.5 nucleic acid), 0.69 weight % D-xylose, and 0.14 weight % glycine.

In the method for manufacturing freeze-dried powdered fish paste according to the present disclosure, the method may further include a packaging step S7′ of subdividing and packaging the surimi powder after the mixing step S7. The packaging step S7′ may include subdividing and vacuum-packaging the surimi powder by a known method. The vacuum-packaged freeze-dried powdered fish paste may be stored for a long time, and consumers may easily purchase the freeze-dried powdered fish paste from retailers, mix the same with water to form a dough, shape the mixture into various forms such as round, triangular, rectangular, half-moon, or star shapes, and then fry, steam, or bake the shaped mixture for cooking.

According to a second embodiment, the present disclosure provides a fish cake manufacturing method including:
a preparing step of preparing surimi powder manufactured by the method for manufacturing freeze-dried powdered fish paste according to the first embodiment;
an intermediate product manufacturing step S8 of manufacturing paste-like fish-based intermediate product by adding purified water to the surimi powder and mixing the purified water with the surimi powder; and
a fish cake manufacturing step S9 of manufacturing fish cake by shaping and heating the fish-based intermediate product.

In the fish cake manufacturing method according to the present disclosure, the weight ratio of the surimi powder to purified water may be 1:3 to 1:5.

In the fish cake manufacturing method according to the present disclosure, the shaping may include round, triangular, square, crescent, star-shaped, oval, spherical, bar-shaped, or flat shapes, but is not limited thereto.

In the fish cake manufacturing method according to the present disclosure, the heating may include frying, roasting, or steaming, but is not limited thereto.

Hereinafter, various embodiments are presented to aid understanding of the present disclosure. The following embodiments are provided merely for easier understanding of the present disclosure, and it should be understood that the scope of the present disclosure is not limited to the following embodiments.

### EMBODIMENTS

### Comparative Example 1. Manufacturing of Fish Cake According to the Conventional Fish Cake Manufacturing Process

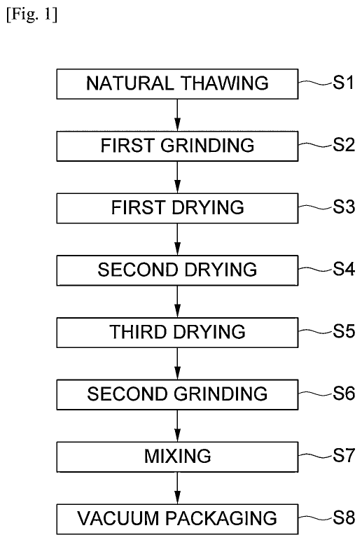

Fish cake is manufactured according to the conventional fish cake manufacturing process shown in FIG. 1. First, the heads, entrails, bones, and skins of fishes such as croaker and squid were removed to extract fish meat, which is then washed with cold water and quickly frozen. This the frozen surimi is placed in a thawing container and naturally thawed for 10 hours. Relative to 100 parts by weight of the thawed fish meat, 2 parts by weight of salt, 0.01 parts by weight of sodium saccharin, and 0.2 parts by weight of L-glutamic acid sodium are added and mixed for seasoning, and then ground within a fish meat grinder at approximately 5° C. for 20 minutes. The first-ground surimi is placed in a vacuum freeze dryer and subjected to a vacuum pressure of 10-5 mmHg and microwaves at 2.54 GHz while being dried at 50° C. for 2 hours. After the first drying, the surimi is further dried in the vacuum freeze dryer at a vacuum pressure of 10-5 mmHg at 10° C. for 3 hours. Subsequently, the second-dried surimi is vacuum dried in the vacuum freeze dryer at a vacuum pressure of 10-5 mmHg at 10° C. for an additional 3 hours. Subsequently, the third-dried surimi is finely ground into powder with particles of 150 to 200 mesh using a cryogenic grinder with liquid nitrogen as the refrigerant. Relative to 100 parts by weight of ground surimi powder, 20 parts by weight of wheat flour and 5 parts by weight of kelp powder is added and then mixed within a mixer at high speed for 5 minutes at 10° C. to obtain surimi powder. Purified water was added to the obtained surimi powder and mixed to produce fish paste, which was then steamed at approximately 200° C. to produce the fish cake.

### Embodiment 1. Manufacturing of Freeze-Dried Powdered Fish Paste According to the Present Disclosure

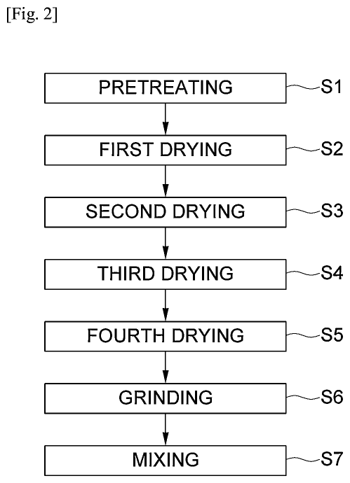

Powdered fish paste is manufactured according to the diagram illustrating a fish cake manufacturing process of the present disclosure shown in FIG. 2. First, the heads, entrails, bones, and skins of fishes such as croaker and squid are removed to extract surimi, which is then washed with cold water and quickly frozen. This frozen surimi is then cut into pieces with a thickness of about 1 to 1.5 cm and rapidly frozen at temperatures of 40° C. or less. The frozen surimi is subjected to first drying at 10° C. for 12 hours under a vacuum pressure of 105 Pa, followed by second drying at 20° C. for 2 hours under a vacuum pressure of 105 Pa, third drying at 30° C. for 12 hours under a vacuum pressure of 105 Pa, and then fourth drying at 40° C. for 25 hours under a vacuum pressure of 105 Pa. The fourth-dried frozen surimi is ground into powder with particles of 150 to 200 mesh using a grinder, and the powdered frozen surimi (surimi powder) is mixed with 13.74% by weight of wheat flour, 10.30% by weight of potato starch, 4.12% by weight of refined salt, 1.37% by weight of sugar, 0.96% by weight of seasoning (2.5% nucleic acid), 0.69% by weight of D-glucose, and 0.14% by weight of glycine to obtain powdered fish paste. Purified water was added to the powdered fish paste and mixed to produce fish paste, which was then steamed at approximately 200° C. to produce the fish cake.

### Experimental Example

### Experimental Example 1. Measurement of Gel Strength

The gel strength or jelly strength of fish cake is measured using a Texture Analyzer (CT3 10K, AMETEK, USA). Fish cake is cut into a predetermined size (25×25×20 mm) and analyzed at room temperature. Analysis conditions of the Texture Analyzer are as follows: probe: 0.25 inch spherical stainless, test speed: 1.0 mm/s. The gel strength is represented as the product of the load (g) applied to the probe and the depth (cm) the probe penetrates when the fish cake ruptures.

TABLE 1

| Fish cake | Gel strength (g/cm) |
|---|---|
| Comparative Example 1 | 113.2 |
| Experimental Example 1 | 219.4 |

As can be seen from Table 1, the fish paste according to the present disclosure has a gel strength of 219.4 g/cm, which is significantly increased compared to the gel strength of 113.2 g/cm of the conventional fish cake.

### 2. Sensory Evaluation

The sensory evaluation of the prepared fish cake was conducted with a panel of 20 members from Samjin Food, and the members of the panel were educated on the testing method and characteristics to be evaluated. The sensory characteristics evaluated were appearance (outward appearance), color, flavor, taste, chewiness, hardness, and overall acceptance. A Likert scale ranging from 5 points (“very good”) to 1 point (“very bad”) was used for the evaluation.

TABLE 2

| | Sensory evaluation (/5 points) | | | | | | |
|---|---|---|---|---|---|---|---|
| Fish cake | Appearance | Color | Flavor | Taste | Chewiness | Hardness | Overall |
| Comparative | 2.8 | 3.1 | 2.3 | 2.8 | 1.5 | 1.7 | 2.0 |
| Example 1 | | | | | | | |
| Experimental | 2.7 | 3.0 | 2.9 | 3.0 | 4.3 | 4.2 | 3.2 |
| Example 1 | | | | | | | |

As can be seen from Table 2, the overall sensory evaluation score of the fish cake according to the present disclosure is higher than that of conventional fish cake. In particular, the evaluations of taste, chewiness, and hardness are significantly improved compared to the conventional fish cakes.

Although the present disclosure has been described in detail with reference to the specific features, it will be apparent to those skilled in the art that this description is only for a preferred example and does not limit the scope of the present disclosure. Thus, the substantial scope of the present disclosure will be defined by the appended claims and equivalents thereof.

What is claimed is:

1. A method for manufacturing freeze-dried powdered fish paste, the method comprising:
a pretreating step of pretreating frozen surimi;
a first drying step of drying the pretreated frozen surimi at 5 to 15° C. for 10 to 15 hours under a vacuum pressure of 10⁴ Pa to 10⁶ Pa;
a second drying step of drying the first-dried surimi at 15 to 25° C. under a vacuum pressure of 10⁴ Pa to 10⁶ Pa for 1 to 3 hours;
a third drying step of drying the second-dried surimi at 25 to 35° C. for 10 to 15 hours under a vacuum pressure of 10⁴ Pa to 10⁶ Pa;
a fourth drying step of drying the third-dried surimi at 35 to 45° C. for 20 to 30 hours under a vacuum pressure of 10⁴ Pa to 10⁶ Pa;
a grinding step of grinding the fourth-dried surimi into powder; and
a mixing step of mixing additives with the ground surimi powder.

2. The method of claim 1, wherein the pretreating step comprises cutting the frozen surimi into pieces with a thickness of 1 to 1.5 cm and rapidly freezing the pieces at −80° C. to −40° C.

3. The method of claim 1, wherein the mixing step comprises mixing additives including wheat starch, potato starch, refined salt, sugar, nucleic acid 2.5, D-xylose, and glycine with the ground surimi powder.

4. The method of claim 3, wherein the mixing step comprises 65 to 75 weight % ground surimi powder, 10 to 15 weight % wheat starch, 8 to 13 weight % potato starch, 3 to 5 weight % refined salt, 0.5 to 2 weight % sugar, 0.5 to 1.5 weight % nucleic acid, 0.5 to 1 weight % D-xylose, and 0.1 to 0.3 weight % glycine based on a total weight of the freeze-dried powdered fish paste.

5. The method of claim 1, further comprising, after the mixing step, a packaging step of subdividing and packaging the surimi powder.

6. A fish cake manufacturing method comprising:
a preparing step for preparing surimi powder manufactured by the method for manufacturing freeze-dried powdered fish paste according to claim 1;
an intermediate product manufacturing step of manufacturing a paste-like fish-based intermediate product by adding purified water to the surimi powder and mixing the purified water with the surimi powder; and
a fish cake manufacturing step of manufacturing fish cake by shaping and heating the fish-based intermediate product.

7. The method of claim 6, wherein the heating comprises frying, roasting, or steaming.
